(19) United States
(12) Patent Application Publication
(10) Pub. No.: US 2026/0350857 A1
(43) Pub. Date: Nov. 5, 2026

(54) IMAGE GENERATION METHOD

(71) Applicant: ALIBABA INNOVATION PRIVATE LIMITED, Singapore (SG)

(72) Inventors: Zhiheng LIU, Hangzhou, Zhejiang (CN); Yifei ZHANG, Hangzhou, Zhejiang (CN); Yujun SHEN, Hangzhou, Zhejiang (CN); Kecheng ZHENG, Hangzhou, Zhejiang (CN); Kai ZHU, Hangzhou, Zhejiang (CN); Ruili FENG, Hangzhou, Zhejiang (CN); Yu LIU, Beijing (CN); Deli ZHAO, Hangzhou, Zhejiang (CN); Jingren ZHOU, Bellevue, WA (US)

(21) Appl. No.: 19/486,378

(22) PCT Filed: Apr. 23, 2024
(86) PCT No.: PCT/SG2024/050262

§ 371 Date: Nov. 21, 2025

(30) Foreign Application Priority Data
May 22, 2023 (CN) 202310594509.2

(51) Int. Cl. G06T 11/00; G06N 3/0455; G06N 3/08

(52) U.S. Cl. CPC G06T 11/00; G06N 3/0455; G06N 3/08

(57) ABSTRACT

Provided in embodiments of the present disclosure is an image generation method. The image generation method includes that: an object description text including at least two objects is inputted into an image generation model to determine an initial text vector of the object description text; pre-stored object vectors of the at least two objects are determined, the pre-stored object vectors being generated based on training text vectors of the at least two objects in a training process of the image generation model; and the initial text vector is processed using the pre-stored object vectors to obtain a target text vector, and an object image including the at least two objects is generated based on the target text vector. Therefore, the low training efficiency of a neural network model and a significant waste of computational resources caused by a large quantity of multi-concept customized statements are avoided.

### CROSS-REFERENCE TO RELATED APPLICATIONS

The present disclosure claims priority of Chinese Patent Application No. 202310594509.2, filed to China National Intellectual Property Administration on May 22, 2023 and titled “IMAGE GENERATION METHOD”, the content of which is hereby incorporated by reference in its entirety.

### TECHNICAL FIELD

Embodiments of the present disclosure relate to the field of computer technologies, and in particular, to an image generation method.

### BACKGROUND OF THE INVENTION

With the continuous advancement of artificial intelligence (AI) technology, in the field of image generation, text-to-image generation techniques in which AI automatically generates images based on some concept description statements have been widely applied in various computer service scenarios. The text-to-image generation techniques are implemented based on artificial intelligence technology. A neural network model is trained using a large quantity of samples to achieve the automatic generation of images by inputting concept description statements into the neural network model. For example, an image of a male wearing sunglasses can be generated by inputting a multi-concept customized statement “a male wearing sunglasses” including two concepts “sunglasses” and “male” into the neural network model.

In related art, in a training process of a neural network model, in order to enable the neural network model to generate multi-concept customized images, the neural network model is instructed to learn each multi-concept customized statement individually. However, due to the vast quantity of concept terms in real-world scenarios, the quantity of multi-concept customized statements formed by combining multiple concept terms becomes extremely large.

This leads to low training efficiency of the neural network model and a significant waste of computational resources.

### SUMMARY OF THE INVENTION

In view of this, embodiments of the present disclosure provide an image generation method. At least one embodiment of the present disclosure relates to a method for training an image generation model, an image generation method, an apparatus for training an image generation model, two image generation apparatuses, a computing device, a computer-readable storage medium, and a computer program, to solve the technical defects in the related art.

According to a first aspect of the embodiments of the present disclosure, an image generation method is provided, including the following steps.

An object description text including at least two objects is inputted into an image generation model to determine an initial text vector of the object description text.

Pre-stored object vectors of the at least two objects are determined, the pre-stored object vectors being generated based on training text vectors of the at least two objects in a training process of the image generation model.

The initial text vector is processed using the pre-stored object vectors to obtain a target text vector, and generating an object image including the at least two objects based on the target text vector.

According to a second aspect of the embodiments of the present disclosure, an image generation apparatus is provided, including:
a first vector determination module, configured to input an object description text including at least two objects into an image generation model to determine an initial text vector of the object description text;
a second vector determination module, configured to determine pre-stored object vectors of the at least two objects, the pre-stored object vectors being generated based on training text vectors of the at least two objects in a training process of the image generation model; and an image generation module, configured to process the initial text vector using the pre-stored object vectors to obtain a target text vector, and generate an object image including the at least two objects based on the target text vector.

According to a third aspect of the embodiments of the present disclosure, a method for training an image generation model is provided, including the following steps.

A training sample for the image generation model is determined, the training sample including a sample object description text and reference object images corresponding to the sample object description text.

The sample object description text is inputted into the image generation model, and processing the sample object description text using a text encoding module in the image generation model to obtain a training text vector corresponding to the sample object description text.

The training text vector is decoded using a vector processing module in the image generation model to obtain a sample object image corresponding to the sample object description text, and generating a pre-stored object vector corresponding to a sample object based on the training text vector.

A loss function of the image generation model is determined based on the reference object image and the sample object image, and training the image generation model based on the loss function to obtain a trained image generation model.

According to a fourth aspect of the embodiments of the present disclosure, an apparatus for training an image generation model is provided, including:
a sample determination module, configured to determine a training sample for the image generation model, the training sample including a sample object description text and reference object images corresponding to the sample object description text;
a vector acquisition module, configured to input the sample object description text into the image generation model, and process the sample object description text using a text encoding module in the image generation model to obtain a training text vector corresponding to the sample object description text;
an image acquisition module, configured to decode the training text vector using a vector processing module in the image generation model to obtain a sample object image corresponding to the sample object description text, and generate a pre-stored object vector corresponding to a sample object based on the training text vector; and
a loss determination module, configured to determine a loss function of the image generation model based on the reference object image and the sample object image, and train the image generation model based on the loss function to obtain a trained image generation model.

According to a fifth aspect of the embodiments of the present disclosure, an image generation method is provided, applied to a cloud-side device, and including the following steps.

An object description text sent by an end-side device is received, the object description text including at least two objects.

The object description text is inputted into an image generation model to determine an initial text vector of the object description text.

Pre-stored object vectors of the at least two objects are determined, the pre-stored object vectors being generated based on training text vectors of the at least two objects in a training process of the image generation model.

The initial text vector is processed using the pre-stored object vectors to obtain a target text vector, and generating an object image including the at least two objects based on the target text vector.

The object image is sent to the end-side device.

According to a sixth aspect of the embodiments of the present disclosure, an image generation apparatus is provided, used in a cloud-side device, and including:
a text receiving module, configured to receive an object description text sent by an end-side device, the object description text including at least two objects;
a first vector determination module, configured to input the object description text into an image generation model to determine an initial text vector of the object description text;
a second vector determination module, configured to determine pre-stored object vectors of the at least two objects, the pre-stored object vectors being generated based on training text vectors of the at least two objects in a training process of the image generation model;
an image generation module, configured to process the initial text vector using the pre-stored object vectors to obtain a target text vector, and generate an object image including the at least two objects based on the target text vector; and
an image sending module, configured to send the object image to the end-side device.

According to a seventh aspect of the embodiments of the present disclosure, a computing device is provided, including:
a memory and a processor;
the memory being configured to store computer-executable instructions, the processor being configured to execute the computer-executable instructions, and the computer-executable instructions, when executed by the processor, implementing the steps of the foregoing two image generation methods and the method for training the image generation model.

According to a seventh aspect of the embodiments of the present disclosure, a computer-readable storage medium is provided, storing computer-executable instructions, the computer-executable instructions, when executed by a processor, implementing the steps of the foregoing two image generation methods and the method for training the image generation model.

According to a ninth aspect of the embodiments of the present disclosure, a computer program is provided, the computer program, when executed in a computer, causing the computer to perform the steps of the foregoing two image generation methods and the method for training the image generation model.

The image generation method provided in the present disclosure includes that: an object description text including at least two objects is inputted into an image generation model to determine an initial text vector of the object description text; pre-stored object vectors of the at least two objects are determined, the pre-stored object vectors being generated based on training text vectors of the at least two objects in a training process of the image generation model; and the initial text vector is processed using the pre-stored object vectors to obtain a target text vector, and an object image including the at least two objects is generated based on the target text vector.

Specifically, in this method, the image generation model does not need to learn each multi-concept customized statement. Instead, the image generation model is trained to learn each individual object (concept). Therefore, the low training efficiency of a neural network model and a significant waste of computational resources caused by a large quantity of multi-concept customized statements are avoided. In addition, in a model training process, for each individual object, a pre-stored object vector corresponding to the object is generated and stored. Therefore, during actual application, when the object description text including at least two objects is inputted into the image generation model, the image generation model can determine pre-stored object vectors corresponding to the at least two objects, combine the pre-stored object vector of each object with an initial text vector of the object description text, and then generate an object image including the at least two objects based on the combined target text vector, to ensure the smooth operation of the image generation model, thereby providing a stable image generation capability.

### BRIEF DESCRIPTION OF DRAWINGS

FIG. 1 is a structural schematic diagram of a multi-concept customization model according to some embodiments of the present disclosure.

FIG. 2 is a schematic diagram of an application scenario of an image generation method according to some embodiments of the present disclosure.

FIG. 3 is a flowchart of an image generation method according to some embodiments of the present disclosure.

FIG. 4 is a flowchart of a processing process of an image generation method according to some embodiments of the present disclosure.

FIG. 5 is a flowchart of another image generation method according to some embodiments of the present disclosure.

FIG. 6 is a flowchart of a method for training an image generation model according to some embodiments of the present disclosure.

FIG. 7 is a structural schematic diagram of an image generation apparatus according to some embodiments of the present disclosure.

FIG. 8 is a structural schematic diagram of an apparatus for training an image generation model according to some embodiments of the present disclosure.

FIG. 9 is a structural schematic diagram of another image generation apparatus according to some embodiments of the present disclosure.

FIG. 10 is a structural block diagram of a computing device according to some embodiments of the present disclosure.

FIG. 11 is a structural schematic diagram of a processor according to some embodiments of the present disclosure.

### DETAILED DESCRIPTION OF THE INVENTION

In the following description, many specific details are described to make the present disclosure fully comprehensible. However, the present disclosure can be implemented in other manners different from those described herein. A person having ordinary skill in the art may make similar extensions without contradicting the content of the present disclosure. Therefore, the protection scope of the present disclosure is not limited to specific embodiments disclosed below.

The terms used in at least one embodiment of the present disclosure are intended for the purpose of describing specific embodiments and are not intended to limit at least one embodiment of the present disclosure. The singular forms of “a”, “an”, and “the” as used in at least one embodiment of the present disclosure and in the appended claims are also intended to include most forms unless the context clearly indicates otherwise. It should also be understood that the term “and/or” as used in at least one embodiment of the present disclosure refers to and includes any or all possible combinations of at least one of the associated listed item.

It should be understood that while the terms “first”, “second”, and the like is used in at least one embodiment of the present disclosure to describe various kinds of information, such information should not be limited to these terms. These terms are used for distinguishing between the same type of information from one another. For example, without departing from the scope of at least one embodiment of the present disclosure, “first” may also be referred to as “second”, and similarly, “second” may also be referred to as “first”. Depending on the context, for example, the term “if” as used herein is interpreted as “at . . . ” or “when . . . ” or “in response to determining”.

It should be noted that all user information (including, but not limited to, user equipment information, and user personal information) and data (including, but not limited to, data for analysis, stored data, and displayed data) in the present disclosure are information and data that are authorized by users or fully authorized by all parties. The collection, use, and processing of related data must comply with applicable laws, regulations, and standards in relevant countries and regions, and corresponding operational entries are provided for users to choose whether to grant or deny authorization.

First, nouns and terms in at least one embodiment of the present disclosure are explained.

Diffusion model: a diffusion model is inspired by non-equilibrium thermodynamics, and is a new SOTA in deep generative models.

Customized generation: a generation task based on related user-specified concepts.

Multi-subject customization: generating multiple user-provided customized concepts within a single image.

SOTA (State-of-the-Art): used for describing models that achieve currently optimal performance on a task in machine learning.

U-Net: an image segmentation network.

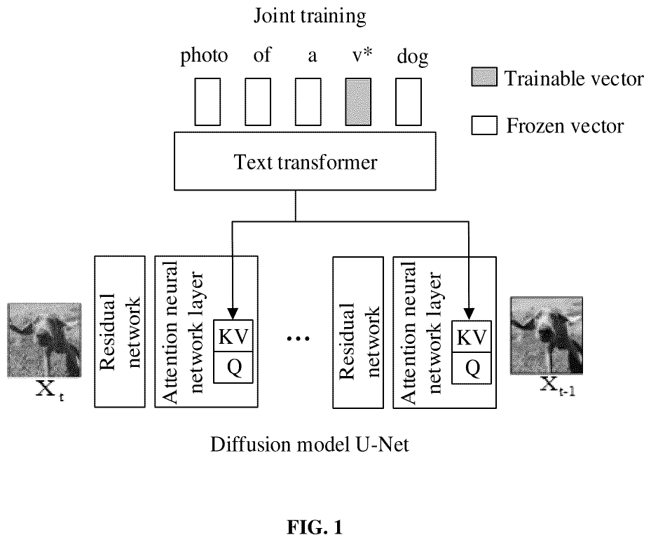

Since text-to-image generation techniques implemented based on neural network models have been widely applied in various computer service scenarios, in a training process of a neural network model, to enable the neural network model to generate multi-concept customized images, the neural network model is instructed to learn each multi-concept customized statement individually. However, due to the vast quantity of concept terms in real-world scenarios, the quantity of multi-concept customized statements formed by combining multiple concept terms becomes extremely large. As a result, some multi-subject image generation methods are prone to attribute confusion when synthesizing multiple subjects (concepts such as “sunglasses” and “male”), resulting in reduced similarity between a generated image and a reference image. In addition, in most of these methods, data of multiple concepts is trained jointly, necessitating retraining as long as a new custom object needs to be customized, causing a significant waste of computational resources. For example, diffusion models are parametric neural networks, image distributions are learned through gradual denoising. Therefore, to further explore the scalability of diffusion models, much work focuses on diffusion-based conditional generation, which is roughly classified into two types. The first type is referred to as a classifier guidance method, in which a classifier is leveraged to steer a sampling process of a pre-trained unconditional model. The second type is referred to as a classifier-free method, in which large-scale data pairs are directly collected to perform joint optimization under the guarantee of conditional probability derivation. This method can generate high-fidelity results but requires a large quantity of data and computational resources In addition, advances in language and cross-modal foundation models have proliferated text-to-image work using classifier-free techniques, which facilitates explicit control over corresponding semantics and styles. However, textual expressiveness is still limited. More work expects to leverage additional conditional information (reference images, backgrounds, and sketches) to further guide global control. In addition, diffusion models for text-to-image generation guide this denoising process through text prompts describing image content. Such models are typically trained by denoising noisy images, resulting in low training efficiency of the models. It should be specifically noted that the present disclosure provides a multi-concept customization model for text-to-image diffusion, and a basic idea thereof is to obtain a better customized generation effect through the fine adjustment of a cross-attention mechanism. However, low training efficiency of models and a significant waste of computational resources still exist. An objective of customized generation is to embed a given subject into a diffusion model and bind a unique text identifier to the diffusion model to indicate the presence of the diffusion model. In this way, the model may vividly generate various renditions of the subject under the guidance of a text prompt. As shown in FIG. 1, FIG. 1 is a structural schematic diagram of a multi-concept customization model according to some embodiments of the present disclosure. The multi-concept customization model is a diffusion model U-Net. The model uses a joint training method, and directly uses a multi-concept customized statement including multiple concepts to train the model. A specific process is as follows. A multi-concept customized statement “photo of a v*dog” is inputted into a text transformer, and the “photo of a v*dog” is mapped to an embedding vector using the text transformer. It should be noted that the embedding vector output by the text transformer may have dimensions of 77*1024. Some dimensions in the 77 dimensions correspond to the terms in the phrase “photo of a v*dog”. For example, the first several dimensions in the 77 dimensions respectively align with each term in the phrase “photo of a v*dog”, and the term “dog” in “photo of a v*dog” occupies the fifth position of the 1024-dimensional vector. After being obtained, the embedding vector of the statement is fed into different Attention layers (attention neural network layers). Through these Attention layers and a residual network (ResNet), a noisy dog image of Xₜ is restored to a clear dog image of Xₜ₋₁. A trainable vector is a vector that needs to be trained and fine-tuned in a diffusion model, that is, a “v*” vector in FIG. 1. A frozen vector is a vector that is fixed in the diffusion model and does not need to be trained, that is, “photo”, “of”, “a”, “dog”, or the like in FIG. 1. Based on this, in the present disclosure, an image generation method is provided. The present disclosure also relates to a method for training an image generation model, an image generation method, an apparatus for training an image generation model, two image generation apparatuses, a computing device, a computer-readable storage medium, and a computer program, which are described in detail one by one in the following embodiments.

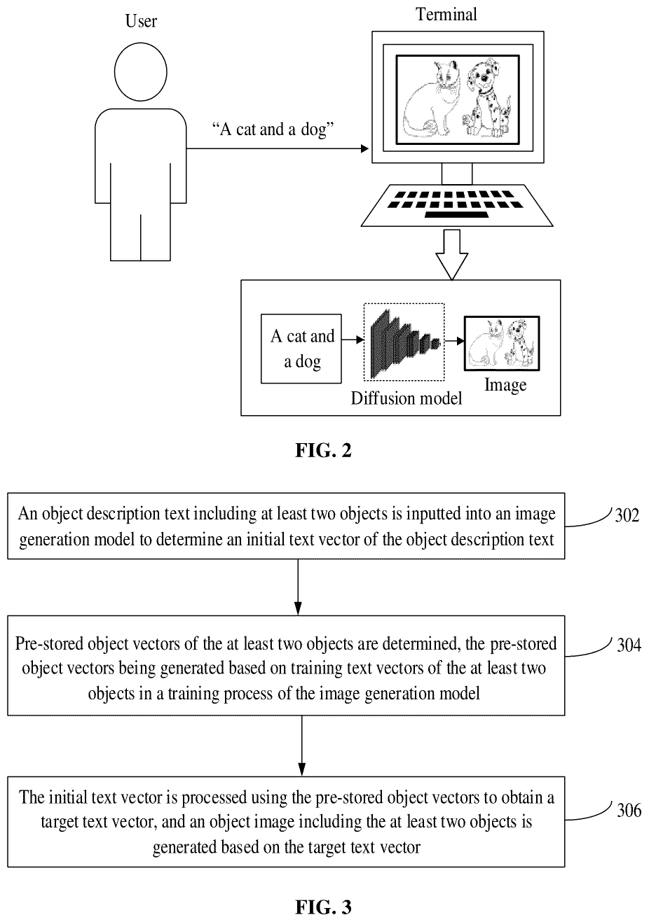

FIG. 2 is a schematic diagram of an application scenario of an image generation method according to some embodiments of the present disclosure. It can be learned as shown in FIG. 2 that a user inputs text “a cat and a dog” into a terminal. After receiving the text, the terminal inputs the text into a diffusion model, and encodes the text using an encoder in the diffusion model to obtain a text embedding vector. In addition, residual vectors of objects such as a cat and a dog are determined from pre-buffered residual vectors based on terms such as “cat” and “dog” in the text. The residual vectors are added to the text embedding vector to generate corresponding objects such as a cat or a dog in a generated image. In this way, a multi-concept customized image is obtained. Based on this, in the image generation method provided in the present disclosure, one residual vector is found for each concept (object), and the residual vector can be infinitely reused. In addition, multiple concepts are combined without training. Different from a manner in which multiple concepts are trained jointly in other methods, computational resources are greatly saved.

FIG. 3 is a flowchart of an image generation method according to some embodiments of the present disclosure. The method specifically includes the following steps.

In step 302, an object description text including at least two objects is inputted into an image generation model to determine an initial text vector of the object description text.

Each object is understood as a specific subject that needs to be generated into an image, and the object includes, but is not limited to, an object, an animal, a plant, a person, and scenery. For example, the object is sunglasses, a cat, a dog, a male, or the like, which is not specifically limited in the present disclosure. The object is understood as a concept, a subject, or the like in the foregoing embodiments. The object description text including at least two objects is understood as language used for describing two or more objects. For example, the statement “a male wearing sunglasses” describes two objects “sunglasses” and “male”. The statement “a cat and a dog” describes two objects “cat” and “dog”. During actual application, the object description text is set for an actual requirement, which is not specifically limited in the present disclosure. The image generation model is understood as a model that can generate the object image including the at least two objects based on the object description text including the at least two objects. For example, the image generation model is a neural network model, a diffusion model, or the like that implements text-to-image generation techniques. This is not specifically limited in the present disclosure. The initial text vector is understood as a feature vector representing each term in the object description text. For example, the initial text vector is a text embedding vector corresponding to the statement “a cat and a dog”. It needs to be noted that the dimension of the text embedding vector is set according to an actual application scenario.

Specifically, in the image generation method provided in the present disclosure, the object description text including the at least two objects can be obtained, and the object description text is inputted into the image generation model, to determine the initial text vector corresponding to the object description text. Further, in some embodiments provided in the present disclosure, in order to ensure that the image generation model can generate a vivid and accurate object image, a text encoding module in the image generation model needs to encode the object description text, so that an accurate object image can be subsequently generated based on an encoded text embedding vector. Specifically, an operation of inputting the object description text including at least two objects into the image generation model to determine the initial text vector of the object description text includes the following steps.

The object description text including the at least two objects is determined.

The object description text is inputted into the image generation model, and the object description text is processed using a text encoding module in the image generation model to obtain the initial text vector corresponding to the object description text.

In some embodiments provided in the present disclosure, the object description text including at least two objects is provided by a user. Based on this, an operation of determining the object description text including the at least two objects includes the following step.

An image generation request is received, and the object description text including the at least two objects is acquired from the image generation request. The image generation request is understood as a request for instructing a computing device to which the image generation method is applied to generate the object image. It needs to be noted that the image generation method provided in the present disclosure is applied to a computer, a mobile phone, a client, a mobile terminal, a server, among other computing devices, which is not specifically limited in the present disclosure.

It can be learned from this that, in the image generation method provided in the present disclosure, the image generation request sent by a user can be received, and the image generation request carries the object description text including at least two objects. Subsequently, the object description text including the at least two objects is inputted into the image generation model in response to the image generation request to obtain the object image including the at least two objects, thereby generating the corresponding object image according to different requirements of the user.

In addition, in some special computer service scenarios, the object description text including at least two objects is pre-stored in the computing device to which the image generation method is applied. After the image generation request is received, locally stored object description text can be quickly obtained, to generate the object image corresponding to the object description text. Specifically, based on this, an operation of determining the object description text including the at least two objects includes the following step.

A text identifier is acquired from the image generation request, and the object description text corresponding to the text identifier is determined from pre-stored object description text, where the object description text includes the at least two objects.

The text identifier is understood as information uniquely identifying one object description text. For example, the object description text “a cat and a dog” is represented by a character A. Based on this, in the image processing method provided in the present disclosure, when an image generation request sent by a user or another computing device is received, the text identifier is acquired from the image generation request. The object description text corresponding to the text identifier is rapidly determined from locally stored object description text including the at least two objects. Subsequently, the object description text is inputted into the image generation model to obtain the object image including the at least two objects.

The text encoding module is understood as a network layer, in the image generation model, which encodes the object description text. For example, the text encoding module is a text encoder.

Specifically, in the image generation method provided in the present disclosure, after the object description text including the at least two objects is determined, the object description text is inputted into the image generation model, and the object description text is encoded using the text encoding module in the image generation model to obtain a term text vector corresponding to each term in the object description text. The term text vector corresponding to each term forms the initial text vector corresponding to the object description text.

For example, the object description text is “a cat and a dog”. Based on this, the object description text is inputted into the text encoder in the diffusion model, and “a cat and a dog” is encoded using the text encoder to obtain a text embedding vector corresponding to each term.

In step 304, pre-stored object vectors of the at least two objects are determined, the pre-stored object vectors being generated based on training text vectors of the at least two objects in a training process of the image generation model.

A pre-stored object vector is understood as a residual vector corresponding to a single object, and the residual vector is generated in a process of training the image generation model. In addition, the residual vector is stored in the computing device to which the image generation method is applied. During actual application, the pre-stored object vector may also be understood as a remaining token embedding or a residual mark embedding of each individual object.

The training text vector is understood as a text embedding vector generated after each sample object description text is encoded in a training process of the image generation model.

Specifically, in some embodiments provided in the present disclosure, an operation of determining the pre-stored object vectors of the at least two objects includes the following steps.

Object identification terms in the object description text are determined, the object description text containing the object identification terms and object feature terms other than the object identification terms, and one object identification term indicating one object.

Target pre-stored object vectors associated with the object identification terms are determined from the pre-stored object vectors.

The target pre-stored object vectors are determined as the pre-stored object vectors of the at least two objects.

The object identification term is understood as a term that directly represents a specific object in the object description text. One object identification term directly represents one object, and one object is determined based on the object identification term. For example, in the object description text “a male wearing sunglasses”, two terms “sunglasses” and “male” directly indicate two objects “sunglasses” and “male”. Therefore, “sunglasses” and “male” are object identification terms. For another example, in the object description text “a cat and a dog”, two terms “cat” and “dog” directly represent two objects “cat” and “dog”. Therefore, “cat” and “dog” are object identification terms.

The object feature term is understood as a term that describes features of an object in the object description text. Some attribute features of a specific object is determined by the object feature term. For example, in the object description text “a cat and a dog”, the term “a” describes that the cat and the dog are respectively one, and the term “and” describes that the cat and the dog are both displayed in the image. Therefore, “a” and “and” are object feature terms. It needs to be noted that in some embodiments, other terms than object identification terms in one object description text are object feature terms.

Specifically, in the image generation method provided in the present disclosure, the object identification term in the object description text needs to be determined using the image generation model, and the target pre-stored object vector associated with the object identification term needs to be determined from locally pre-stored object vectors. The target pre-stored object vectors are then determined as the pre-stored object vectors of the at least two objects. The foregoing example continues to be used. After the object description text “a cat and a dog” is inputted into a diffusion model, the diffusion model determines two terms “cat” and “dog” from “a cat and a dog”, and determines residual vectors corresponding to the two terms “cat” and “dog” from multiple locally stored residual vectors. The residual vectors are residual vectors corresponding to the two concepts “cat” and “dog”.

Based on this, in the image generation method provided in the present disclosure, one residual vector is found for each concept (object) and stored, and the residual vector can be infinitely reused. In addition, the residual vector corresponding to each concept needs a small storage space, for example, approximately 5 kb, thereby avoiding that other multi-concept customized generation methods require parameters of a diffusion model to be stored with full digital precision. Therefore, for a large-scale application program in a mobile device, large costs is incurred. In the image generation method provided in the present disclosure, a text embedding residual vector of each concept is stored, and a small storage space is required, thereby reducing costs.

In step 306, the initial text vector is processed using the pre-stored object vectors to obtain a target text vector, and an object image including the at least two objects is generated based on the target text vector.

The target text vector is understood as a vector obtained after the initial text vector is adjusted based on the pre-stored object vector. The object image including the at least two objects is understood as an image including two or more objects, for example, an image including a cat and a dog, or an image including a male wearing sunglasses.

In some embodiments provided in the present disclosure, the image generation method provided in the present disclosure provides a multi-subject image generation method. In the method, a residual vector of a single subject is learned to implement customized synthesis of multiple subjects, to subsequently generate a multi-concept customized image based on a combination of the multiple residual vectors. Specifically, an operation of processing the initial text vector using the pre-stored object vectors to obtain the target text vector includes the following steps.

Vectors to be adjusted corresponding to the at least two objects are determined from the initial text vector based on the object identification terms in the object description text.

The pre-stored object vectors are added to the vectors to be adjusted in the initial text vector to obtain the target text vector.

A vector to be adjusted is understood as a text embedding vector corresponding to each object. Specifically, in the image generation method provided in the present disclosure, the object identification terms in the object description text are determined using the image generation model, and the vectors to be adjusted corresponding to the at least two objects are determined from the initial text vector based on the object identification terms. The vectors to be adjusted in the initial text vector are adjusted based on the pre-stored object vectors to obtain the target text vector. For example, in the image generation method provided in the present disclosure, after the diffusion model determines residual vectors of two objects “cat” and “dog”, text embedding vectors corresponding to the two terms “cat” and “dog” are determined from a text embedding vector of the object description text “a cat and a dog” as text embedding vectors corresponding to the two objects “cat” and “dog”. The residual vectors of the two objects “cat” and “dog” are then added with the corresponding text embedding vectors, to add the residual vectors to a basic category embedding vector of the object description text “a cat and a dog”, thereby generating a final text embedding vector including the residual vectors of the objects. Corresponding subjects (“cat” and “dog”) are generated in an image generated based on the final text embedding vector.

In some embodiments provided in the present disclosure, after the target text vector is determined, the target text vector is processed using the vector processing module in the image generation model to generate the object image including the at least two objects. Specifically, an operation of generating the object image including the at least two objects based on the target text vector includes the following step.

The target text vector is processed using a vector processing module in the image generation model to obtain the object image including the at least two objects.

The vector processing module is understood as a module that decodes the target text vector to generate an object image. For example, the vector processing module is a U-Net model. For example, after the final text embedding vector including the residual vectors of the objects is obtained, the text embedding vector is inputted into the U-Net model for decoding, to obtain an image including a cat and a dog.

Further, in the embodiments provided in the present disclosure, the image generation method provided in the present disclosure solves the problem of high consumption of computational resources in a model training process, and can also avoid, in a model application stage, the problem of attribute confusion during the generation of a multi-subject image (i.e., a multi-concept customized image). Other multi-subject image generation methods are easily prone to attribute confusion during the synthesis of multiple subjects, resulting in reduced similarity between a generated image and a reference image. For example, a dog and a cat overlap in images. Therefore, this method provides a method based on a customized diffusion model. A residual vector of a single subject is learned to implement customized synthesis of multiple subjects, thereby avoiding the occurrence of an attribute confusion problem. Specifically, an operation of processing the target text vector using the vector processing module in the image generation model to obtain the object image including the at least two objects includes the following steps.

The target text vector is decoded using the vector processing module to obtain image features corresponding to the object description text.

The image features are adjusted based on object display location parameters of the at least two objects to obtain adjusted image features.

The adjusted image features are continued to be decoded to obtain the object image including the at least two objects.

The image features is understood as an attention map determined for each term in the object description text using an attention mechanism by the vector processing module in a process of generating the object image based on the target text vector. That is, the image features is understood as an attention map.

The object display location parameters are understood as parameters indicating a display location of each object in the object image. The parameters include coordinate information or region information. During actual application, in order to implement high-quality multi-subject (i.e., object) generation, in this method, a layout (i.e., an object display location parameter) is used as a spatial guidance for arranging subjects into the attention map. The layout is an abstract and easily accessible prior. A user may define the layout as a group of subject boundary boxes, which describe spatial composition of subjects. Specifically, in this solution, required regions corresponding to these subjects are respectively emphasized in the attention map, and at the same time, a limitation is imposed on a region related to another subject based on a layout prior to obtain an adjusted attention map. Subsequently, an accurate object image is generated based on the attention map, thereby avoiding attribute confusion.

For example, in the image generation method provided in the present disclosure, after the text embedding vector including the residual vectors is obtained, the text embedding vector is first inputted into a U-net model (i.e., a vector processing module). The U-net model decodes the text embedding vector to determine an attention map of the text embedding vector using an attention mechanism. Each term corresponds to one attention map. Second, the two objects are arranged into spatial positions in the attention map based on a layout provided by the user for the two objects “cat” and “dog” to obtain an adjusted attention map. Finally, an image including a cat and a dog is generated using the U-net model based on the adjusted attention map, so that each object can be accurately displayed in the image, thereby avoiding attribute confusion of the object.

Further, in the embodiments provided in the present disclosure, an operation of adjusting the image features based on object display location parameters of the at least two objects to obtain adjusted image features includes the following steps.

The object display location parameters of the at least two objects are acquired, and target object display location parameters corresponding to a target object are determined from the object display location parameters, the target object being any one of the at least two objects.

Target object image features corresponding to the target object are determined from the image feature.

A target location of the target object in the target object image features is determined based on the object display location parameters, and adjusting an object display weight of the target object at the target location to obtain the adjusted image features.

The target object is understood as any one of the at least two objects. For example, the at least two objects are two objects “cat” and “dog”, and the target object refers to a cat or a dog.

The target object image features are a cross-attention map corresponding to the target object in multiple attention maps. For example, each term in the object description text “a cat and a dog” has a cross-attention map corresponding to this term. Cross-attention maps corresponding to the two terms “cat” and “dog” are cross-attention maps corresponding to the two objects “cat” and “dog”.

The object display weight is understood as a weight of a target object displayed in a specific region, or it is understood as that the object display weight is a signal of the target object in an image region in which the user expects the target object to appear. A stronger weight or signal indicates higher accuracy of displaying the target in the image region. A weaker weight or signal indicates lower accuracy of displaying the target in the image region.

The foregoing example continues to be used. A first issue that addressed by the image processing method provided in the present disclosure for multi-subject customization is that some subjects may fail to be displayed based on description in a text prompt. In this method, it is considered that this is caused by insufficient activation values in the cross-attention maps of the subjects. To avoid this case, this solution chooses to enhance a signal of a target subject in a region in which a user expects the target subject to appear and suppress a signal of an unrelated subject. A second issue in multi-subject customization is attribute confusion, in which a subject in a generated image may include a feature of another subject. In this solution, it is considered that this is caused by overlapping activation regions of different subjects in the cross-attention map. To avoid this case, this method chooses to suppress a signal component of each custom object appearing in a region of another custom object.

Based on this, in the method, a layout sent by a user for the two objects “cat” and “dog” is acquired, and cross-attention maps corresponding to “cat” and “dog”. That is, cross-attention maps corresponding to the two terms “cat” and “dog”, are determined from multiple cross-attention maps corresponding to the text embedding vector of “a cat and a dog”. A display region of each object in the corresponding cross-attention map is determined based on a layout prior provided by a user. For example, a display region of the object “dog” in the cross-attention map corresponding to “dog” is determined. A display region of the object “cat” in the cross-attention map corresponding to “cat” is determined. A weight of a corresponding object is then enhanced in each region, and a weight of each object in another region is lowered. For example, a signal (i.e., a weight) of the object “dog” is enhanced in the region corresponding to the object “dog”, and a signal of the object “dog” in the display region of another object is lowered, thereby choosing to enhance a signal of a target subject (object) in a region in which the object is expected to appear and suppressing a signal of an unrelated subject, and in addition, choosing to suppress a signal component of each custom object appearing in a region of another custom object, so that attribute confusion is resolved using an attention mechanism.

Specifically, for a manner of adjusting a target subject signal in different regions in a cross-attention map based on a cross-attention mechanism, refer to the following Formula (1). Formula 1 represents how to enhance a signal component of a target object in a region of the target object and suppress a signal component of the target object in a region of another object.

EditedCA(CA, M, c)=Softmax(CA)⊕{η(t)·Mₛᵢ|=1 . . . , N})·(Wᵥ·E(c)) (Formula 1)

EditedCA represents the cross-attention mechanism. CA represents the attention map. Softmax is an activation function. t represents time. C represents an input text embedding (embedding vector). S represents the dimension of an object (e.g., a dog). E represents the average value. W represents the weight matrix. M is the binarization of layout provided by the user. For example, in the binarization of layout, a region corresponding to the object is assigned either 1 or 0. η is a weight parameter.

In some embodiments provided in the present disclosure, for the problem that in a process of training multi-concept data jointly, retraining is required as long as a new custom object needs to be customized, this method provides a training-free method that combines multiple concepts. A residual vector needs to be found for each concept in a model training process, and the residual vector can be infinitely reused. Based on this, a training process of the image generation model in this method is specifically as follows. Before inputting object description text including at least two objects into an image generation model to determine an initial text vector of the object description text, the image generation method further includes the following steps.

A training sample for an image generation model is determined, the training sample including sample object description text and reference object images corresponding to the sample object description text.

The sample object description text is inputted into the image generation model, and the sample object description text is processed using a text encoding module in the image generation model to obtain a training text vector corresponding to the sample object description text.

The training text vector is decoded using a vector processing module in the image generation model to obtain a sample object image corresponding to the sample object description text, and a pre-stored object vector corresponding to a sample object is generated based on the training text vector.

A loss function of the image generation model is determined based on the reference object image and the sample object image, and training the image generation model based on the loss function to obtain a trained image generation model.

The sample object description text is understood as description text that is used as a sample for a single object, for example, “an image of a dog”, “a photo of a cat”, and “a photo of dog”. The reference object image is understood as an image of an object described in the sample object description text. For example, the sample object description text is “an image of a dog”, and the reference object image is an image of a dog.

The training text vector is understood as a text embedding vector corresponding to the sample object description text.

For example, in the solution for training an image generation model provided in this method, an objective of training a diffusion model in this solution is to generate a new vivid and accurate image that includes any combination of these subjects. Based on this, in this method, a residual vector corresponding to each object needs to be determined. Subsequently, a residual vector of a specific subject is combined with a pre-trained diffusion model, and a layout guidance generation process is used to achieve this objective.

Training of a diffusion model includes the following steps. A group of subjects (the sample object description text), for example, “a photo of dog”, and three to five sample photos (the reference object images) of a dog corresponding to the group of subjects are given from different perspectives as training samples. “a photo of dog” is inputted into a text encoder in the diffusion model, and a text embedding vector (a training text vector) corresponding to “a photo of dog” is output.

The text embedding vector is inputted into a U-Net model in the diffusion model to obtain a generated image corresponding to the text embedding vector. In addition, in this solution, a residual vector corresponding to the object “dog” can be generated based on the text embedding vector corresponding to “a photo of dog”.

After the image generated by the U-Net model is obtained, a loss function for the diffusion model is determined based on the generated image and the sample photos, and the diffusion model is trained based on the loss function until the training stopping criterion is met, to obtain the trained diffusion model.

In some embodiments provided in this specification, in order to reduce a waste of computational resources, a pre-stored object vector corresponding to each object needs to be determined, and a manner for generating the pre-stored object vector is as follows. An operation of generating the pre-stored object vector corresponding to the sample object based on the training text vector includes the following steps.

A first sample object text vector corresponding to the sample object is determined from the training text vector based on a sample object identification term in the sample object description text.

The sample object description text is inputted into a text encoding module in an untrained image generation model to obtain an untrained text vector of the sample object description text.

A second sample object text vector corresponding to the sample object is determined from the untrained text vector based on the sample object identification term.

An average difference between the first sample object text vector and the second sample object text vector is determined as the pre-stored object vector of the sample object.

The sample object is understood as an object used as a sample. The sample object is consistent with the object in the foregoing embodiment. The sample object identification term is understood as a term that directly represents a specific sample object in a sample description text. One sample object identification term directly represents one sample object. For example, in the sample object description text “a photo of dog”, the term “dog” directly represents the sample object “dog”. The first sample object text vector is understood as a text embedding vector corresponding to a sample object in the training text vector. The pre-training image generation model is an image generation model before current model training is performed for the image generation model. The untrained text vector is a text embedding vector that is obtained using a text encoding module in the pre-training image generation model and corresponds to the sample object description text.

The foregoing example continues to be used. In a text-to-image generation model (diffusion model), a text provided by a user is encoded by a text encoder to obtain a corresponding text embedding vector. In this method, in a process of determining the residual vector of each object, an average variation is to be sought. The average variation is an average value of a dimension of a custom object (e.g., custom dog) calculated by a training text encoder and a frozen text encoder in various text. For example, the various text includes “a dog is on a beach”, and “a dog is sleeping”. “frozen” represents that a model is fixed and does not need to be trained. Therefore, the frozen text encoder is an encoder that is fixed in the diffusion model and does not need to be trained. An average difference of the text in the vector dimension “dog” (i.e., the first sample object text vector and the second sample object text vector) of the embedding vectors (i.e., the training text vector and the untrained text vector) output by the two text encoders is calculated, and the average difference is used as a residual vector. It needs to be noted that for a calculation method of the residual vector, refer to the following Formula (2). Formula (2) represents that a method for searching for each concept is calculating category-to-specific object residual vectors of a training text encoder and an original text encoder in under different text:

$${Δ}_{dog}^{custom} = \frac{1}{\vert {C}_{dog} \vert} \cdot {\sum }_{c ∈ {C}_{dog}} ( {{E}^{custom} ( c )}_{dog} - {E ( c )}_{dog} ) . \qquad Formula ( 2 )$$

$${Δ}_{dog}^{custom}$$

represents the residual vector of the object “dog”. C_{dog} is text all related to “dog”, and is used to calculate an average value of the changes. E^{custom} is the training text encoder. C is the input text embedding.

In the embodiments provided in the present disclosure, in a process of training an image generation model, the main content of the training is giving a small quantity of images of a given custom subject, and a text encoder is fine-tuned, to learn a residual embedding on a basic embedding of an original subject. A specific calculation manner of fine-tuning a current data loss is as follows. An operation of determining the loss function of the image generation model based on the reference object image and the sample object image includes the following steps.

A first loss function of the image generation model is determined based on the reference object image and the sample object image.

A second loss function of the image generation model is determined based on the untrained text vector and the training text vector.

The first loss function and the second loss function are added to obtain the loss function of the image generation model.

The foregoing example continues to be used. In the present disclosure, in a process of training the diffusion model, after an image is generated using the u-Net model, a first loss function is calculated by using the image and a sample parameter image. For the loss function, refer to the following Formula (3).

$${Ls}_{sub} = {E}_{{x}^{i} , ∈ , t} [ {ω}_{t} {‖ {\hat{x}}_{θ} ( {x}_{t}^{i} , t , {c}^{x} ) - {x}^{i} ‖}_{2}^{2} ] \qquad Formula ( 3 )$$

E is calculating an average value, and Xe is the diffusion model and parameters. Xⁱ is the real noise.

$${\hat{x}}_{θ} ( {x}_{t}^{i} , t , {c}^{x} )$$

is the predicted noise. C is the input text embedding. t is time.

After the first loss function is determined, the embedding vectors output by the training text encoder and the frozen text encoder are determined. Other embedding vectors than an embedding vector corresponding to a sample object are respectively determined from the two embedding vectors. A second loss function is calculated based on the other embedding vectors. Refer to the following Formula (4) for the loss function. Formula (4) is to search for a residual of each concept.

$${L}_{reg} ( {E}^{custom} ) = {E}_{c ∼ {C}_{dog}} [ {\sum }_{p ∈ c , p \neq s} {‖ {{E}^{custom} ( c )}_{p} - {E ( c )}_{p} ‖}_{2}^{2} ] \qquad Formula ( 4 )$$

E^{custom} is the training text encoder. p is the dimension. S is the dimension of an object (e.g., “dog”). C is the input text embedding. E represents the average value. C_{dog} is all text related to “dog”.

Finally, the loss of the overall diffusion model is a sum of adding the two losses.

In the image generation method provided in the present disclosure, the image generation model does not need to learn each multi-concept customized statement. Instead, the image generation model is trained to learn each individual object (concept). Therefore, the low training efficiency of a neural network model and a significant waste of computational resources caused by a large quantity of multi-concept customized statements are avoided. In addition, in a model training process, for each individual object, a pre-stored object vector corresponding to the object is generated and stored. Therefore, during actual application, when the object description text including at least two objects is inputted into the image generation model, the image generation model can determine the pre-stored object vectors corresponding to the at least two objects, combine the pre-stored object vector of each object with the initial text vector of the object description text, and then generate the object image including the at least two objects based on the combined target text vector, to ensure the smooth operation of the image generation model, thereby providing a stable image generation capability.

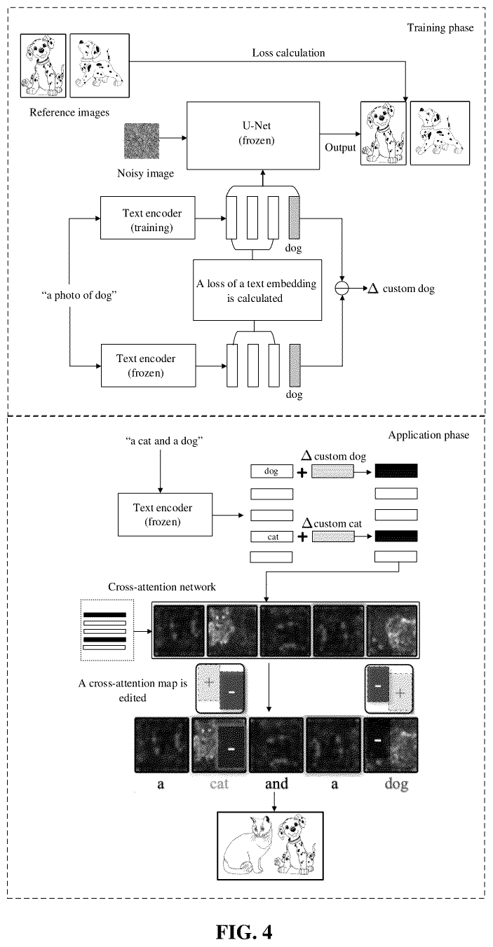

With reference to FIG. 4, the image generation method provided in the present disclosure is further described below by using an example in which the image generation method is applied to a scenario of multi-concept customized generation in a diffusion model. FIG. 4 is a flowchart of a processing process of an image generation method according to some embodiments of the present disclosure. It is learned according to FIG. 4 that, the image generation method provided in the present disclosure includes a training phase and an application phase.

A processing process for the training phase is as follows.

First, a group of text (i.e., text “a photo of dog” in FIG. 4) is given as a training sample from different perspectives, and reference images (two to five images of a dog) corresponding to the training sample are determined. The training sample is inputted into a text encoder for training to obtain a text embedding vector corresponding to the training sample. The text embedding vector is inputted into a frozen U-Net model. The U-Net model generates an image using a noisy image and the text embedding vector to obtain an image output by the model. The diffusion model includes the text encoder and the U-Net model.

Next, the training sample “a photo of dog” is inputted into a frozen text encoder to obtain a corresponding text embedding vector. The frozen text encoder is an original text encoder before a current round of training.

Text embedding vectors output by the two text encoders are determined. An average difference between text embedding vectors of the dimension “dog” in the two text embedding vectors is calculated, and the average difference is used as a residual vector of the object “dog” (A custom in FIG. 4).

Finally, a loss function (i.e., the foregoing Formula 3) is calculated based on the generated image output by the U-Net model and the reference images. Another loss function (i.e., the foregoing Formula 4) is calculated by using text embedding vectors of dimensions other than the dimension “dog” in the two text embedding vectors. The two loss functions are used as an overall loss function of the diffusion model, and the diffusion model is trained based on the overall loss function to obtain a trained diffusion model.

A processing process for the training phase is as follows.

First, a text “a cat and a dog” sent by a user is received. The text is inputted into a frozen text encoder in the diffusion model to obtain a text embedding vector.

Text embedding vectors of two objects “cat” and “dog” are determined from the text embedding vector, and residual vectors corresponding to “cat” and “dog” are obtained from locally buffered residual vectors (i.e.,

$${Δ}_{dog}^{custom} and {Δ}_{cat}^{custom}$$

in FIG. 4). The residual vectors and the text embedding vectors of the two objects are added, to add the residual vectors to the text embedding vector corresponding to “a cat and a dog”.

Next, the text embedding vector is processed using an attention mechanism, to determine a cross-attention map corresponding to each term in “a cat and a dog”. For the cross-attention map of the two objects “cat” and “dog”, regions of the two objects in the cross-attention map are determined based on a layout provided by a user (an abstract and easily accessible prior, which is defined by the user as a group of subject boundary boxes), a weight of a corresponding object is enhanced in each region, and a weight of each object in another region is lowered.

Finally, after the cross-attention map is edited, an image including a cat and a dog is generated based on the cross-attention map with the adjusted weights.

It can be known based on the foregoing content that, in the image generation method provided in the present disclosure, a remaining token embedding (i.e., a residual vector) of a specific subject is combined with a pre-trained diffusion model, and a generation process is guided using a layout, thereby vividly and accurately generating a new image including any combination of subjects. Each subject is represented as a remaining token embedding (i.e., a residual vector) transferred from a basic category of the subject. A corresponding subject is generated in a generated image by adding a residual mark embedding (i.e., a residual vector) to a basic category embedding (i.e., an embedding obtained by processing “a cat and a dog” using a text encoder). In addition, during reasoning, two key problems of subject absence and attribute confusion between different subjects in multi-subject customized generation, are overcome.

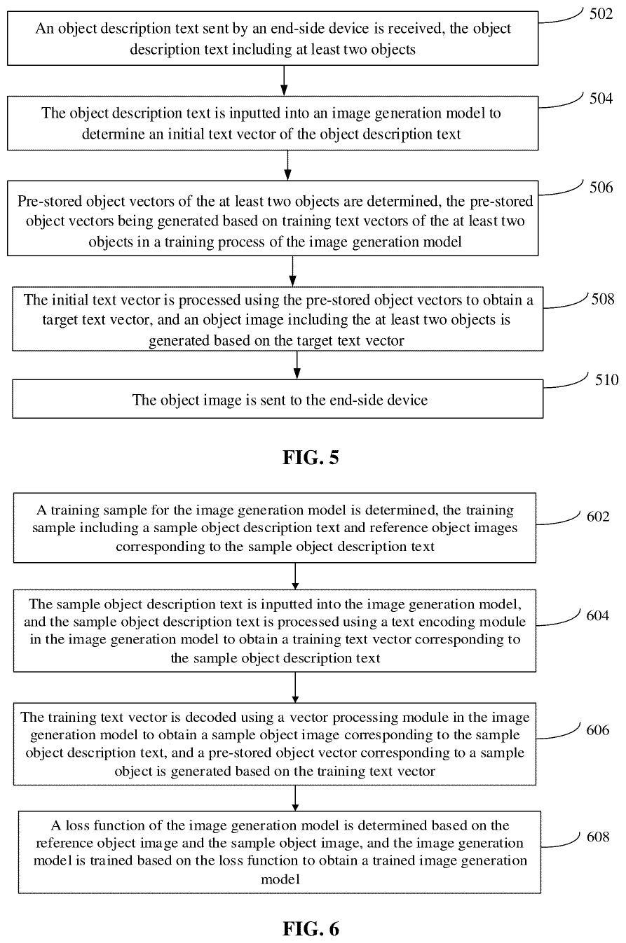

FIG. 5 is a flowchart of another image generation method according to some embodiments of the present disclosure. The image generation method is applied to a cloud-side device, and specifically includes the following steps.

In step 502, an object description text sent by an end-side device is received, the object description text including at least two objects.

In step 504, the object description text is inputted into an image generation model to determine an initial text vector of the object description text.

In step 506, pre-stored object vectors of the at least two objects are determined, the pre-stored object vectors being generated based on training text vectors of the at least two objects in a training process of the image generation model.

In step 508, the initial text vector is processed using the pre-stored object vectors to obtain a target text vector, and an object image including the at least two objects is generated based on the target text vector.

In step 510, the object image is sent to the end-side device.

The cloud-side device is understood as a device that is located on a cloud side and can provide a cloud service to the end-side device. For example, the cloud-side device is at least one server or at least one host. In some embodiments provided in the present disclosure, the cloud-side device may alternatively be formed by a cloud-side computing device and/or a cloud-side storage device. The cloud-side computing device is understood as a device that is located on a cloud side and can provide a computing service to the end-side device. For example, the cloud-side computing device is at least one server. The cloud-side storage device is understood as a device that is located on a cloud side and can provide a storage service to the end-side device, for example, at least one database storage server, or a cloud disk. The end-side device is understood as a device that exists relative to the cloud-side device and can use the cloud service provided by the cloud-side device. The end-side device includes, but is not limited to, a client, a terminal, a computer, a server, a mobile phone, or an intelligent mobile device.

Specifically, another image generation method provided in the present disclosure can be applied to a cloud-side device. When receiving an object description text sent by an end-side device, the object description text including at least two objects is inputted into the image generation model, and the initial text vector of the object description text is obtained using the text encoding module in the image generation model. The pre-stored object vectors of the at least two objects are then determined, and the initial text vector is adjusted based on the pre-stored object vectors, to add the pre-stored object vectors to the initial text vector to obtain a target text vector. The target text vector is processed using the image generation model to obtain the object image including the at least two objects. After the object image is obtained, the object image is sent to the end-side device.

Based on this, in this image generation method applied to a cloud-side device provided in the present disclosure, the image generation model does not need to learn each multi-concept customized statement. Instead, the image generation model is trained to learn each individual object (concept). Therefore, the low training efficiency of a neural network model and a significant waste of computational resources caused by a large quantity of multi-concept customized statements are avoided. In addition, in a model training process, for each individual object, a pre-stored object vector corresponding to the object is generated and stored.

Therefore, during actual application, after an object description text sent by an end-side device is acquired, the object description text including at least two objects is inputted into the image generation model, and the image generation model can determine the pre-stored object vectors corresponding to the at least two objects, combine the pre-stored object vector of each object with the initial text vector of the object description text, then generate the object image including the at least two objects based on the combined target text vector, and return the object image to the end-side device, to ensure the smooth operation of an image generation model, so that the cloud-side device can stably provide an image generation capability to the end-side device.

The foregoing is a schematic solution of another image generation method in the embodiments. It needs to be noted that the technical solution of this image generation method belongs to the same concept as the technical solution of the foregoing image generation method. For details that are not described in detail in the technical solution of this image generation method, refer to the description of the technical solution of the foregoing image generation method, and no further details are provided herein.

FIG. 6 is a flowchart of a method for training an image generation model according to some embodiments of the present disclosure. The method specifically includes the following steps.

In step 602, a training sample for the image generation model is determined, the training sample including a sample object description text and reference object images corresponding to the sample object description text.

In step 604, the sample object description text is inputted into the image generation model, and the sample object description text is processed using a text encoding module in the image generation model to obtain a training text vector corresponding to the sample object description text.

In step 606, the training text vector is decoded using a vector processing module in the image generation model to obtain a sample object image corresponding to the sample object description text, and a pre-stored object vector corresponding to a sample object is generated based on the training text vector.

In step 608, a loss function of the image generation model is determined based on the reference object image and the sample object image, and the image generation model is trained based on the loss function to obtain a trained image generation model.

Specifically, for the description of the technical solution of the method for training an image generation model, refer to corresponding description in the foregoing image generation method. Details are not described in the present disclosure again.

In the method for training an image generation model provided in the present disclosure, the image generation model does not need to learn each multi-concept customized statement. Instead, the image generation model is trained to learn each individual object (concept). Therefore, the low training efficiency of a neural network model and a significant waste of computational resources caused by a large quantity of multi-concept customized statements are avoided. In addition, in a model training process, for each individual object, a pre-stored object vector corresponding to the object is generated and stored. Therefore, during subsequent actual application, when the object description text including the at least two objects is inputted into the image generation model, the image generation model can determine the pre-stored object vectors corresponding to the at least two objects, combine the pre-stored object vector of each object with the initial text vector of the object description text, and then generate the object image including the at least two objects based on the combined target text vector, to ensure the smooth operation of the image generation model, thereby providing a stable image generation capability.

The foregoing is a schematic solution of a method for training the image generation model in the embodiments. It needs to be noted that the technical solution of the method for training the image generation model belongs to the same concept as the technical solution of the foregoing image generation method. For details that are not described in detail in the technical solution of the method for training an image generation model, refer to the description of the technical solution of the foregoing image generation method, and no further details are provided herein.

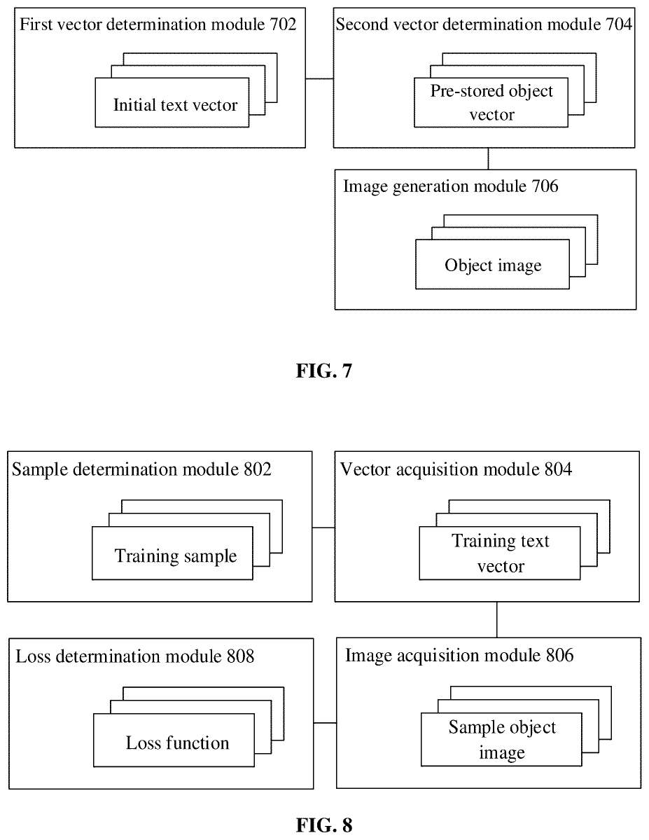

Corresponding to the foregoing method embodiments, the present disclosure further provides some embodiments of an image generation apparatus. FIG. 7 is a structural schematic diagram of an image generation apparatus according to some embodiments of the present disclosure. As shown in FIG. 7, the apparatus includes:

a first vector determination module 702, configured to input an object description text including at least two objects into an image generation model to determine an initial text vector of the object description text;
a second vector determination module 704, configured to determine pre-stored object vectors of the at least two objects, the pre-stored object vectors being generated based on training text vectors of the at least two objects in a training process of the image generation model; and
an image generation module 706, configured to process the initial text vector using the pre-stored object vectors to obtain a target text vector, and generate an object image including the at least two objects based on the target text vector.

Optionally, the second vector determination module 704 is further configured to:
determine object identification terms in the object description text, the object description text containing the object identification terms and object feature terms other than the object identification terms, and one object identification term indicating one object;
determine target pre-stored object vectors associated with the object identification terms from the pre-stored object vectors; and
determine the target pre-stored object vectors as the pre-stored object vectors of the at least two objects.

Optionally, the image generation module 706 is further configured to:
determine vectors to be adjusted corresponding to the at least two objects from the initial text vector based on the object identification terms in the object description text; and
add the pre-stored object vectors to the vectors to be adjusted in the initial text vector to obtain the target text vector.

Optionally, the image generation module 706 is further configured to:
process the target text vector using a vector processing module in the image generation model to obtain the object image including the at least two objects.

Optionally, the image generation module 706 is further configured to:
decode the target text vector using the vector processing module to obtain image features corresponding to the object description text;
adjust the image features based on object display location parameters of the at least two objects to obtain adjusted image features; and
continue to decode the adjusted image features to obtain the object image including the at least two objects.

Optionally, the image generation module 706 is further configured to:
acquire the object display location parameters of the at least two objects, and determine target object location parameters corresponding to a target object from the object display location parameters, the target object being any one of the at least two objects;
determine target object image features corresponding to the target object from the image feature; and
determine a target location of the target object in the target object image features based on the object display location parameter, and adjust an object display weight of the target object at the target location to obtain the adjusted image feature.

Optionally, the first vector determination module 702 is further configured to:
determine the object description text including the at least two objects; and
input the object description text into the image generation model, and process the object description text using a text encoding module in the image generation model to obtain the initial text vector corresponding to the object description text.

Optionally, the first vector determination module 702 is further configured to:
receive an image generation request, and acquire the object description text including the at least two objects from the image generation request; or
acquire a text identifier from the image generation request, and determine the object description text corresponding to the text identifier from pre-stored object description text, where the object description text includes the at least two objects.

Optionally, the image generation module further includes a model training module, configured to:
determine a training sample for an image generation model, the training sample including a sample object description text and reference object images corresponding to the sample object description text;
input the sample object description text into the image generation model, and process the sample object description text using a text encoding module in the image generation model to obtain a training text vector corresponding to the sample object description text;
decode the training text vector using a vector processing module in the image generation model to obtain a sample object image corresponding to the sample object description text, and generate a pre-stored object vector corresponding to a sample object based on the training text vector; and
determine a loss function of the image generation model based on the reference object image and the sample object image, and train the image generation model based on the loss function to obtain a trained image generation model.

Optionally, the model training module is further configured to:
determine a first sample object text vector corresponding to the sample object from the training text vector based on a sample object identification term in the sample object description text;
input the sample object description text into a text encoding module in an untrained image generation model to obtain an untrained text vector of the sample object description text;
determine a second sample object text vector corresponding to the sample object from the untrained text vector based on the sample object identification term; and
determine an average difference between the first sample object text vector and the second sample object text vector as the pre-stored object vector of the sample object.

Optionally, the model training module is further configured to:
determine a first loss function of the image generation model based on the reference object image and the sample object image;
determine a second loss function of the image generation model based on the untrained text vector and the training text vector; and
add the first loss function and the second loss function to obtain the loss function of the image generation model.

In the image generation apparatus provided in the embodiments of the present disclosure, the image generation model does not need to learn each multi-concept customized statement.

Instead, the image generation model is trained to learn each individual object (concept). Therefore, the low training efficiency of a neural network model and a significant waste of computational resources caused by a large quantity of multi-concept customized statements are avoided. In addition, in a model training process, for each individual object, a pre-stored object vector corresponding to the object is generated and stored. Therefore, during actual application, when the object description text including at least two objects is inputted into the image generation model, the image generation model can determine pre-stored object vectors corresponding to the at least two objects, combine the pre-stored object vector of each object with the initial text vector of the object description text, and then generate the object image including the at least two objects based on the combined target text vector, to ensure the smooth operation of the image generation model, thereby providing a stable image generation capability.

The foregoing is a schematic solution of the image generation apparatus in the embodiments. It needs to be noted that the technical solution of the image generation apparatus belongs to the same concept as the technical solution of the foregoing image generation method. For details that are not described in detail in the technical solution of the image generation apparatus, refer to the description of the technical solution of the foregoing image generation method.

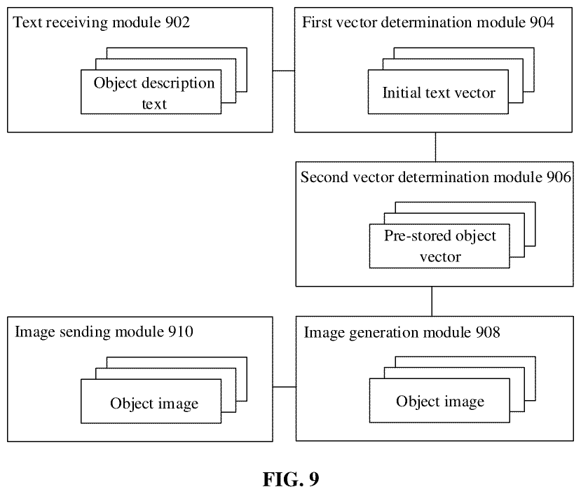

Corresponding to the foregoing method embodiments, the present disclosure further provides some embodiments of an apparatus for training an image generation model. FIG. 8 is a structural schematic diagram of an apparatus for training an image generation model according to some embodiments of the present disclosure. As shown in FIG. 8, the apparatus includes: a sample determination module 802, configured to determine a training sample for the image generation model, the training sample including a sample object description text and reference object images corresponding to the sample object description text;
a vector acquisition module 804, configured to input the sample object description text into the image generation model, and process the sample object description text using a text encoding module in the image generation model to obtain a training text vector corresponding to the sample object description text;
an image acquisition module 806, configured to decode the training text vector using a vector processing module in the image generation model to obtain a sample object image corresponding to the sample object description text, and generate a pre-stored object vector corresponding to a sample object based on the training text vector; and
a loss determination module 808, configured to determine a loss function of the image generation model based on the reference object image and the sample object image, and train the image generation model based on the loss function to obtain a trained image generation model.

For the apparatus for training the image generation model provided in the present disclosure, the image generation model does not need to learn each multi-concept customized statement. Instead, the image generation model is trained to learn each individual object (concept). Therefore, the low training efficiency of a neural network model and a significant waste of computational resources caused by a large quantity of multi-concept customized statements are avoided. In addition, in a model training process, for each individual object, a pre-stored object vector corresponding to the object is generated and stored. Therefore, during subsequent actual application, when the object description text including at least two objects is inputted into the image generation model, the image generation model can determine pre-stored object vectors corresponding to the at least two objects, combine the pre-stored object vector of each object with the initial text vector of the object description text, and then generate the object image including the at least two objects based on the combined target text vector, to ensure the smooth operation of the image generation model, thereby providing a stable image generation capability.

The foregoing is a schematic solution of an apparatus for training the image generation model in the embodiments. It needs to be noted that the technical solution of the apparatus for training the image generation model belongs to the same concept as the technical solution of the foregoing method for training the image generation model. For details that are not described in detail in the technical solution of the method for training the image generation model, refer to the description of the technical solution of the foregoing method for training the image generation model.

Corresponding to the foregoing method embodiments, the present disclosure further provides some embodiments of another image generation apparatus. FIG. 9 is a structural schematic diagram of another image generation apparatus according to some embodiments of the present disclosure. As shown in FIG. 9, the apparatus is applied to a cloud-side device, and includes:
a text receiving module 902, configured to receive an object description text sent by an end-side device, the object description text including at least two objects;
a first vector determination module 904, configured to input the object description text into an image generation model to determine an initial text vector of the object description text;
a second vector determination module 906, configured to determine pre-stored object vectors of the at least two objects, the pre-stored object vectors being generated based on training text vectors of the at least two objects in a training process of the image generation model;
an image generation module 908, configured to process the initial text vector using the pre-stored object vectors to obtain a target text vector, and generate an object image including the at least two objects based on the target text vector; and
an image sending module 910, configured to send the object image to the end-side device.

For the another image generation apparatus applied to the cloud-side device provided in the present disclosure, the image generation model does not need to learn each multi-concept customized statement. Instead, the image generation model is trained to learn each individual object (concept). Therefore, the low training efficiency of a neural network model and a significant waste of computational resources caused by a large quantity of multi-concept customized statements are avoided. In addition, in a model training process, for each individual object, a pre-stored object vector corresponding to the object is generated and stored. Therefore, during actual application, after the object description text sent by an end-side device is acquired, the object description text including at least two objects is inputted into the image generation model, and the image generation model can determine pre-stored object vectors corresponding to the at least two objects, combine the pre-stored object vector of each object with the initial text vector of the object description text, then generate the object image including the at least two objects based on the combined target text vector, and return the object image to the end-side device, to ensure the smooth operation of the image generation model, so that the cloud-side device can stably provide an image generation capability to the end-side device.

The foregoing is a schematic solution of another image generation apparatus in the embodiments. It needs to be noted that the technical solution of this image generation apparatus belongs to the same concept as the technical solution of the foregoing another image generation method. For details that are not described in detail in the technical solution of this image generation apparatus, refer to the description of the technical solution of the foregoing another image generation method.

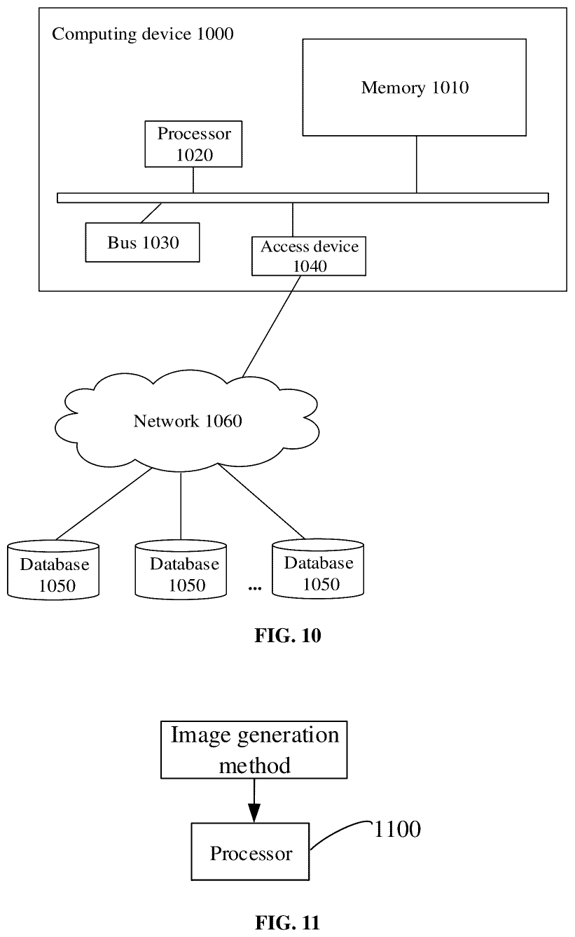

FIG. 10 is a structural block diagram of a computing device 1000 according to some embodiments of the present disclosure. The computing device 1000 includes, but not limited to, a memory 1010 and a processor 1020. The processor 1020 is connected with the memory 1010 by a bus 1030. A database 1050 is configured to store data.

The computing device 1000 further includes an access device 1040. The access device 1040 allows the computing device 1000 to performed communication via at least one network 1060. Examples of these networks include a public switched telephone network (PSTN), a local area network (LAN), a wide area network (WAN), a personal area network (PAN), or a combination of communication networks such as the Internet. The access device 1040 may include at least one of any type of wired or wireless network interface (for example, a network interface card (NIC)), such as an IEEE 802.11 wireless local area network (WLAN) wireless interface, a Worldwide Interoperability for Microwave Access (Wi-MAX) interface, an Ethernet interface, a universal serial bus (USB) interface, a cellular network interface, a Bluetooth interface, a near field communication (NFC) interface, and the like.

In some embodiments of the present disclosure, the above components of the computing device 1000 and other components not shown in FIG. 10 may also be connected with each other, for example, by a bus. It should be understood that the structural block diagram of the computing device shown in FIG. 10 is for exemplary purposes and does not constitute a limitation to the scope of the present disclosure. A person having ordinary skill in the art may add or replace other components as required.

The computing device 1000 is any type of stationary or mobile computing device, including a mobile computer or mobile computing device (for example, a tablet computer, a personal digital assistant, a laptop computer, a netbook, etc.), a mobile phone (for example, a smartphone), a wearable computing device (for example, a smart watch, and smart glasses), or another type of mobile device, or a stationary computing device such as a desktop computer or a PC. The computing device 1000 is a mobile or stationary server.

The processor 1020 is configured to execute the following computer-executable instructions, and the computer-executable instructions, when executed by the processor 1020, implementing the steps of the foregoing two image generation methods and method for training an image generation model.

Embodiments of the present disclosure further provide a processor. FIG. 11 is a structural schematic diagram of a processor configured to implement some embodiments of the present disclosure. As shown in FIG. 11, the processor 1100 is configured to execute a program. The program, when executed by the processor, performs the methods in the foregoing embodiments.

In the embodiments of the present disclosure, the processor 1100 may execute an executable program of the image generation method.

Optionally, in some embodiments, the processor 1100 is configured to perform the following steps:
inputting an object description text including at least two objects into an image generation model to determine an initial text vector of the object description text;
determining pre-stored object vectors of the at least two objects, the pre-stored object vectors being generated based on training text vectors of the at least two objects in a training process of the image generation model; and
processing the initial text vector using the pre-stored object vectors to obtain a target text vector, and generating an object image including the at least two objects based on the target text vector.

Optionally, in some embodiments, the processor 1100 is configured to perform the following steps:
determining a training sample for the image generation model, the training sample including sample object description text and reference object images corresponding to the sample object description text;
inputting the sample object description text into the image generation model, and processing the sample object description text using a text encoding module in the image generation model to obtain a training text vector corresponding to the sample object description text;
decoding the training text vector using a vector processing module in the image generation model to obtain a sample object image corresponding to the sample object description text, and generating a pre-stored object vector corresponding to a sample object based on the training text vector; and
determining a loss function of the image generation model based on the reference object image and the sample object image, and training the image generation model based on the loss function to obtain a trained image generation model.

Optionally, in some embodiments, the processor 1100 is configured to perform the following steps:
receiving an object description text sent by an end-side device, the object description text including at least two objects;
inputting the object description text into an image generation model to determine an initial text vector of the object description text;
determining pre-stored object vectors of the at least two objects, the pre-stored object vectors being generated based on training text vectors of the at least two objects in a training process of the image generation model;
processing the initial text vector using the pre-stored object vectors to obtain a target text vector, and generating an object image including the at least two objects based on the target text vector; and
sending the object image to the end-side device.

The foregoing is a schematic solution of the computing device in the embodiments. It needs to be noted that the technical solution of the computing device belongs to the same concept as the technical solutions of the foregoing two image generation methods and method for training the image generation model. For details that are not described in detail in the technical solution of the computing device, refer to the description of the technical solution of the foregoing two image generation methods and method for training an image generation model.

Some embodiments of the present disclosure further provide a computer-readable storage medium, storing computer-executable instructions, the computer-executable instructions, when executed by a processor, implementing the steps of the foregoing two image generation methods and method for training an image generation model.

The foregoing is a schematic solution of the computer-readable storage medium in the embodiments. It needs to be noted that the technical solution of the storage medium belongs to the same concept as the technical solutions of the foregoing two image generation methods and method for training the image generation model. For details that are not described in detail in the technical solution of the storage medium, refer to the description of the technical solution of the foregoing two image generation methods and method for training the image generation model.

The computer-readable storage medium may include a propagated data signal with readable program code embodied therein, for example, in baseband or as part of a carrier wave. A data signal propagated in such a way may assume multiple forms, including, but not limited to, an electromagnetic signal, an optical signal, or any appropriate combination thereof. The computer-readable storage medium can communicate, propagate, or transport a program for use by or in combination with an instruction execution system, apparatus or device.

Program code embodied on the computer-readable storage medium is transmitted using any appropriate medium, including but not limited to wireless, wired, optical fiber cable, or radio frequency, or any suitable combination of the foregoing.

Some embodiments of the present disclosure further provide a computer program, the computer program, when executed in a computer, causing the computer to perform the steps of the foregoing two image generation methods and method for training the image generation model.

Optionally, program code of the following steps is implemented when the foregoing computer program is executed by a processor:
inputting an object description text including at least two objects into an image generation model to determine an initial text vector of the object description text;
determining pre-stored object vectors of the at least two objects, the pre-stored object vectors being generated based on training text vectors of the at least two objects in a training process of the image generation model; and
processing the initial text vector using the pre-stored object vectors to obtain a target text vector, and generating an object image including the at least two objects based on the target text vector.

Optionally, program code of the following steps is implemented when the foregoing computer program is executed by a processor:
determining a training sample for an image generation model, the training sample including a sample object description text and reference object images corresponding to the sample object description text;
inputting the sample object description text into the image generation model, and processing the sample object description text using a text encoding module in the image generation model to obtain a training text vector corresponding to the sample object description text;
decoding the training text vector using a vector processing module in the image generation model to obtain a sample object image corresponding to the sample object description text, and generating a pre-stored object vector corresponding to a sample object based on the training text vector; and
determining a loss function of the image generation model based on the reference object image and the sample object image, and training the image generation model based on the loss function to obtain a trained image generation model.

Optionally, program code of the following steps is implemented when the foregoing computer program is executed by a processor:
receiving an object description text sent by an end-side device, the object description text including at least two objects;
inputting the object description text into an image generation model to determine an initial text vector of the object description text;
determining pre-stored object vectors of the at least two objects, the pre-stored object vectors being generated based on training text vectors of the at least two objects in a training process of the image generation model;
processing the initial text vector using the pre-stored object vectors to obtain a target text vector, and generating an object image including the at least two objects based on the target text vector; and
sending the object image to the end-side device.

The foregoing is a schematic solution of the computer program in the embodiments. It needs to be noted that the technical solution of the computer program belongs to the same concept as the technical solutions of the foregoing two image generation methods and method for training the image generation model. For details that are not described in detail in the technical solution of the computer program, refer to the description of the technical solution of the foregoing two image generation methods and method for training the image generation model.

Specific embodiments of the present disclosure are described above. Other embodiments fall within the scope of the appended claims. In some embodiments, the actions or steps recorded in the claims are performed in sequences different from those in the embodiments and an expected result may still be achieved. In addition, the processes depicted in the accompanying drawings is not necessarily performed in the specific order or successively to achieve an expected result. In some implementations, multitasking and parallel processing is feasible or beneficial.

The computer instructions include computer program code. The computer program code is in the form of source code, in the form of object code, in the form of an executable file, in some intermediate forms, or the like. The computer-readable medium may include: any entity or apparatus capable of carrying the computer program code, a recording medium, a USB flash drive, a removable hard drive, a disk, an optical disc, a computer memory, a read-only memory (ROM), a random access memory (RAM), an electrical carrier signal, a telecommunication signal, and a software distribution medium, or the like. It should be noted that the content contained in the computer-readable medium is added or omitted as appropriate according to the requirements of legislation and patent practice in the jurisdiction. For example, in some jurisdictions, according to legislation and patent practice, the computer-readable medium does not include an electric carrier signal and a telecommunication signal.

It should be noted that the foregoing method embodiments are presented as a series of actions for simplicity of description, but a person having ordinary skill in the art should be aware that the embodiments of the present disclosure are not limited by the sequence of actions described, as some steps are performed in other sequences or simultaneously according to the embodiments of the present disclosure. Secondly, a person having ordinary skill in the art should also be aware that the embodiments described in the specification are all preferred embodiments and that the actions and modules involved are not necessarily essential for the embodiments of the present disclosure.

In the foregoing embodiments, the description of each embodiment has its own focus, and for what is not described in detail in some embodiments, refer to related description in other embodiments.

The above-disclosed exemplary embodiments of the present disclosure are used for helping illustrate the present disclosure. The optional embodiments are not an exhaustive recitation of all details, nor do they limit the invention to the specific embodiments described. Obviously, many modifications and variations are made in accordance with the content of the present disclosure. These embodiments have been selected and specifically described in the present disclosure to better explain the principles and practical applications of the embodiments of the present disclosure for a person having ordinary skill in the art to which they belong to adequately understand and utilize the present disclosure. The present disclosure is limited by the claims and their full scope and equivalents.

### INDUSTRIAL APPLICABILITY

The solutions provided in the embodiments of the present disclosure are applied to an image generation process. An object description text including at least two objects is inputted into an image generation model, and an initial text vector of the object description text is determined.

Pre-stored object vectors of the at least two objects are determined, the pre-stored object vectors being generated based on training text vectors of the at least two objects in a training process of the image generation model. The initial text vector is processed using the pre-stored object vectors to obtain a target text vector, and an object image including the at least two objects is generated based on the target text vector, thereby solving the technical problem of a significant waste of computational resources.

1. An image generation method, comprising:
inputting an object description text comprising at least two objects into an image generation model to determine an initial text vector of the object description text;
determining pre-stored object vectors of the at least two objects, the pre-stored object vectors being generated based on training text vectors of the at least two objects in a training process of the image generation model; and
processing the initial text vector using the pre-stored object vectors to obtain a target text vector, and generating an object image containing the at least two objects based on the target text vector.

2. The image generation method according to claim 1, wherein determining the pre-stored object vectors of the at least two objects comprises:
determining object identification terms in the object description text, the object description text containing the object identification terms and object feature terms other than the object identification terms, and one object identification term indicating one object;
determining target pre-stored object vectors associated with the object identification terms from the pre-stored object vectors; and
determining the target pre-stored object vectors as the pre-stored object vectors of the at least two objects.

3. The image generation method according to claim 1, wherein processing the initial text vector using the pre-stored object vectors to obtain the target text vector comprises:
determining vectors to be adjusted corresponding to the at least two objects from the initial text vector based on the object identification terms in the object description text; and
adding the pre-stored object vectors to the vectors to be adjusted in the initial text vector to obtain the target text vector.

4. The image generation method according to claim 1, wherein generating the object image containing the at least two objects based on the target text vector comprises:
processing the target text vector using a vector processing module in the image generation model to obtain the object image containing the at least two objects.

5. The image generation method according to claim 4, wherein processing the target text vector using the vector processing module in the image generation model to obtain the object image containing the at least two objects comprises:
decoding the target text vector using the vector processing module to obtain image features corresponding to the object description text;
adjusting the image features based on object display location parameters of the at least two objects to obtain adjusted image features; and
continuing to decode the adjusted image features to obtain the object image containing the at least two objects.

6. The image generation method according to claim 5, wherein adjusting the image features based on the object display location parameters of the at least two objects to obtain the adjusted image features comprises:
acquiring the object display location parameters of the at least two objects, and determining target object location parameters corresponding to a target object from the object display location parameters, the target object being any one of the at least two objects;
determining target object image features corresponding to the target object from the image features; and
determining a target location of the target object in the target object image features based on the object display location parameters, and adjusting an object display weight of the target object at the target location to obtain the adjusted image features.

7. The image generation method according to claim 1, wherein inputting the object description text containing the at least two objects into the image generation model to determine the initial text vector of the object description text comprises:
determining the object description text containing the at least two objects; and
inputting the object description text into the image generation model, and processing the object description text using a text encoding module in the image generation model to obtain the initial text vector corresponding to the object description text.

8. The image generation method according to claim 1, wherein determining the object description text containing the at least two objects comprises:
receiving an image generation request, and acquiring the object description text containing the at least two objects from the image generation request; or
acquiring a text identifier from the image generation request, and determining the object description text corresponding to the text identifier from pre-stored object description texts, wherein the object description text comprises the at least two objects.

9. The image generation method according to claim 1, wherein before inputting the object description text containing the at least two objects into the image generation model to determine the initial text vector of the object description text, the image generation method further comprises:
determining a training sample for the image generation model, the training sample comprising a sample object description text and reference object images corresponding to the sample object description text;
inputting the sample object description text into the image generation model, and processing the sample object description text using a text encoding module in the image generation model to obtain a training text vector corresponding to the sample object description text;
decoding the training text vector using a vector processing module in the image generation model to obtain a sample object image corresponding to the sample object description text, and generating a pre-stored object vector corresponding to a sample object based on the training text vector; and
determining a loss function of the image generation model based on the reference object image and the sample object image, and training the image generation model based on the loss function to obtain a trained image generation model.

10. The image generation method according to claim 9, wherein generating the pre-stored object vector corresponding to the sample object based on the training text vector comprises:
determining a first sample object text vector corresponding to the sample object from the training text vector based on a sample object identification term in the sample object description text;
inputting the sample object description text into a text encoding module in an untrained image generation model to obtain an untrained text vector of the sample object description text;
determining a second sample object text vector corresponding to the sample object from the untrained text vector based on the sample object identification term; and
determining an average difference between the first sample object text vector and the second sample object text vector as the pre-stored object vector of the sample object.

11. The image generation method according to claim 10, wherein determining the loss function of the image generation model based on the reference object image and the sample object image comprises:
determining a first loss function of the image generation model based on the reference object image and the sample object image;
determining a second loss function of the image generation model based on the untrained text vector and the training text vector; and
adding the first loss function and the second loss function to obtain the loss function of the image generation model.

12. (canceled)

13. An image generation method, applied to a cloud-side device, comprising:
receiving an object description text sent by an end-side device, the object description text comprising at least two objects;
inputting the object description text into an image generation model to determine an initial text vector of the object description text;
determining pre-stored object vectors of the at least two objects, the pre-stored object vectors being generated based on training text vectors of the at least two objects in a training process of the image generation model;
processing the initial text vector using the pre-stored object vectors to obtain a target text vector, and generating an object image containing the at least two objects based on the target text vector; and
sending the object image to the end-side device.

14. The image generation method according to claim 13, wherein determining the pre-stored object vectors of the at least two objects comprises:
determining object identification terms in the object description text, the object description text containing the object identification terms and object feature terms other than the object identification terms, and one object identification term indicating one object;
determining target pre-stored object vectors associated with the object identification terms from the pre-stored object vectors; and
determining the target pre-stored object vectors as the pre-stored object vectors of the at least two objects.

15. The image generation method according to claim 13, wherein processing the initial text vector using the pre-stored object vectors to obtain the target text vector comprises:
determining vectors to be adjusted corresponding to the at least two objects from the initial text vector based on the object identification terms in the object description text; and
adding the pre-stored object vectors to the vectors to be adjusted in the initial text vector to obtain the target text vector.

16. (canceled)

17. An electronic device, comprising:
at least one processor; and
a memory associated with the at least one processor, the memory being configured to store program instructions, and the program instructions, when read and executed by the at least one processor, performing the following steps:
inputting an object description text comprising at least two objects into an image generation model to determine an initial text vector of the object description text;
determining pre-stored object vectors of the at least two objects, the pre-stored object vectors being generated based on training text vectors of the at least two objects in a training process of the image generation model; and
processing the initial text vector using the pre-stored object vectors to obtain a target text vector, and generating an object image containing the at least two objects based on the target text vector.

18-20. (canceled)

21. The image generation method according to claim 1, wherein the initial text vector is a feature vector representing each term in the object description text.

22. The image generation method according to claim 1, wherein the pre-stored object vector is a residual vector corresponding to a single object.

23. The image generation method according to claim 1, wherein the training text vector is a text embedding vector generated after each sample object description text is encoded in the training process of the image generation model.

24. The image generation method according to claim 2, wherein the object identification term is a term representing a specific object in the object description text.

25. The image generation method according to claim 2, wherein the object feature term is a term that describes features of an object in the object description text.
